(19) United States
(12) Patent Application Publication
(10) Pub. No.: US 2023/0206135 A1
(43) Pub. Date: Jun. 29, 2023

(54) MACHINE LEARNING-BASED USER SENTIMENT PREDICTION USING AUDIO AND VIDEO SENTIMENT ANALYSIS

(71) Applicant: Dell Products L.P., Round Rock, TX (US)

(72) Inventors: Pranjal Kumar, Patna (IN); Pulkit Rathi, Bhopal (IN); Ian Roche, Glanmire (IE)

(21) Appl. No.: 17/564,695

(22) Filed: Dec. 29, 2021

(51) Int. Cl. G06N 20/20

(52) U.S. Cl. CPC G06N 20/20

(57) ABSTRACT

Techniques are provided for machine learning-based user sentiment prediction using audio and video sentiment analysis. One method comprises obtaining audio sensor data and video sensor from at least one sensor associated with a user; applying the audio sensor data to a first machine learning model that analyzes an audio sentiment of the user to provide an audio sentiment score; applying the video sensor data to a second machine learning model that analyzes a video sentiment of the user to provide a video sentiment score; applying the audio sentiment score and the video sentiment score to an ensemble model that determines an aggregate sentiment score based on the audio sentiment score and the video sentiment score; and initiating an automated remedial action based on the aggregate sentiment score. An output of the ensemble model can be applied to a feedback agent that updates the first and/or second machine learning models.

### FIELD

The field relates generally to information processing systems, and more particularly to user monitoring techniques in such information processing systems.

### BACKGROUND

It is often desirable to determine the sentiment of one or more persons. In an office environment, for example, an organization may monitor employee sentiment in order to maintain a positive work environment (e.g., to improve employee morale, retention and/or productivity).

### SUMMARY

In one embodiment, a method comprises obtaining audio sensor data and video sensor data from at least one sensor associated with at least one user; applying at least some of the audio sensor data to a first machine learning model that analyzes an audio sentiment of the at least one user to provide at least one audio sentiment score; applying at least some of the video sensor data to a second machine learning model that analyzes a video sentiment of the at least one user to provide at least one video sentiment score; applying the at least one audio sentiment score and the at least one video sentiment score to an ensemble model that determines an aggregate sentiment score based at least in part on the at least one audio sentiment score and the at least one video sentiment score; and initiating one or more automated remedial actions based at least in part on the aggregate sentiment score.

In some embodiments, an output of the ensemble model is provided to at least one feedback agent that updates the first machine learning model and/or the second machine learning model. At least some of the audio sensor data and/or the video sensor data can be preprocessed to satisfy one or more data processing criteria of the first machine learning model and/or the second machine learning model. For example, the preprocessing may comprise: (i) selecting a number of audio features to send to the first machine learning model and/or (ii) detecting one or more human faces in the video sensor data and cropping one or more image frames using the detected one or more human faces.

In at least one embodiment, at least some of the video sensor data can be processed to identify one or more user classes that are excluded from group meetings and/or group activities by evaluating pixel coordinates of at least some of the objects in a given image associated with users to identify the one or more excluded user classes.

Other illustrative embodiments include, without limitation, apparatus, systems, methods and computer program products comprising processor-readable storage media.

### BRIEF DESCRIPTION OF THE DRAWINGS

FIG. 1 illustrates an information processing system configured to predict user sentiment in accordance with an illustrative embodiment;

FIG. 2 illustrates an exemplary layout of a space in an exemplary office environment in accordance with an illustrative embodiment;

FIG. 3 illustrates an exemplary prediction of user sentiment using audio and video sentiment analyzers in accordance with an illustrative embodiment;

FIG. 4 illustrates a neural network-based sentiment analyzer in accordance with an illustrative embodiment;

FIG. 5 is a flow chart illustrating an exemplary implementation of a process for predicting user sentiment using audio and video sentiment analysis in accordance with an illustrative embodiment;

FIG. 6 illustrates an exemplary processing platform that may be used to implement at least a portion of one or more embodiments of the disclosure comprising a cloud infrastructure; and

FIG. 7 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for machine learning-based user sentiment prediction using audio and video sentiment analysis.

As noted above, a positive work environment can improve the morale, retention and/or productivity of employees. If employees work in a dreary office setting with unfriendly workers, for example, the employees may not have sufficient confidence to voice their concerns. A lack of proper communication among employees, for example, may indicate an unproductive work environment.

In one or more embodiments, machine learning-based techniques are provided for user sentiment prediction using audio and video sentiment analysis. Sentiment analysis is a method for determining the opinions of individuals or groups to find their attitude towards a topic. Based on a scoring mechanism, sentiment analysis monitors conversations and evaluates language and voice inflections to quantify attitudes, opinions, and emotions related, for example, to a business, product, or topic. A deep learning algorithm-based approach is employed in some embodiments to score the workplace environment using various inputs received from an image-based facial expression recognition model and an audio-based voice sentiment analysis model. The generated sentiment score may be employed to understand the office environment at a more granular level and to transform a stressful office environment into a more relaxed, enjoyable, and open workplace where people can be themselves and collaborate.

Workplace inclusion is an important aspect for an organization. Organizations often struggle, however, to obtain the complete picture within each team and to determine how the overall sentiment is affected. One or more embodiments of the disclosure may process images from at least one video sensor to identify one or more user classes that are excluded from group meetings and/or group activities, as discussed further below. In this manner, an organization may leverage knowledge about users and/or user groups that are excluded from group meetings and/or group activities, in order to reduce workplace discrimination of various forms.

Various aspects of the disclosure recognize that survey-based approaches for evaluating user sentiment demonstrate an inherent bias, due to pressure from upper management, a fear of being excluded from a group based on survey responses and other forms of peer pressure. In addition, it can be shown that such survey-based approaches have failed to reduce key problems, such as workplace discrimination, exclusion from a certain group and the freedom for people to be themselves. Further, survey results are typically obtained at a certain point in time (e.g., quarterly or annually) and are thus not produced in real-time, causing delays in identifying areas requiring improvement.

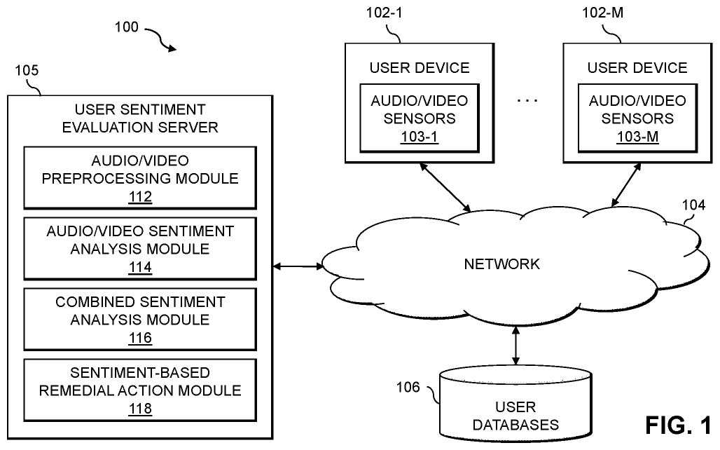

FIG. 1 shows a computer network (also referred to herein as an information processing system) 100 configured in accordance with an illustrative embodiment. The computer network 100 comprises a plurality of user devices 102-1 through 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is one or more user sentiment evaluation servers 105 and user databases 106, discussed below.

The user devices 102 may comprise, for example, host devices and/or devices such as mobile telephones, laptop computers, tablet computers, desktop computers or other types of computing devices. Such devices are examples of what are more generally referred to herein as “processing devices.” Some of these processing devices are also generally referred to herein as “computers.” The user devices 102 may comprise a network client that includes networking capabilities such as ethernet, Wi-Fi, etc. When the user devices 102 are implemented as host devices, the host devices may illustratively comprise servers or other types of computers of an enterprise computer system, cloud-based computer system or other arrangement of multiple compute nodes associated with respective users.

For example, the host devices in some embodiments illustratively provide compute services such as execution of one or more applications on behalf of each of one or more users associated with respective ones of the host devices.

In the example of FIG. 1, the user devices 102 comprise respective audio and/or video sensors 103-1 through 103-M. In addition, the user devices 102 in some embodiments comprise respective processing devices associated with a particular company, organization or other enterprise or group of users. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

It is to be appreciated that the term “user” in this context and elsewhere herein is intended to be broadly construed so as to encompass, for example, human, hardware, software or firmware entities, as well as various combinations of such entities. Compute and/or storage services may be provided for users under a Platform-as-a-Service (PaaS) model, an Infrastructure-as-a-Service (IaaS) model, a Storage-as-a-Service (STaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise.

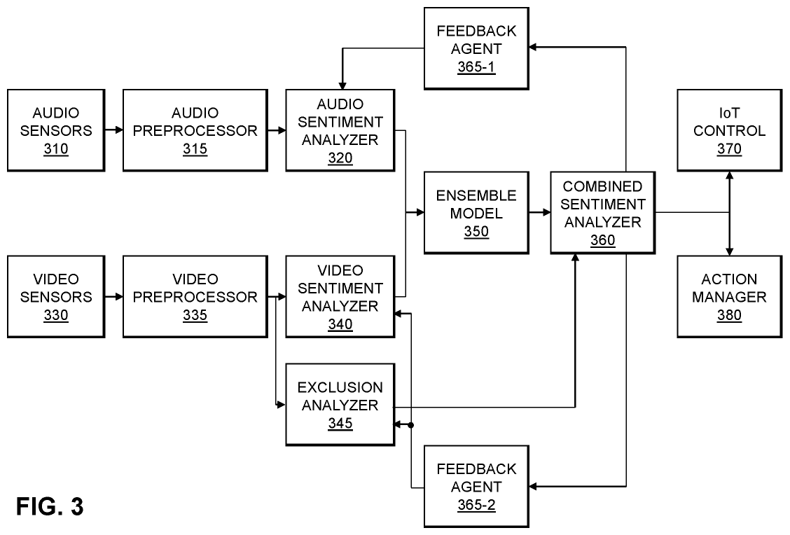

The user sentiment evaluation server 105 may be implemented, for example, on the cloud or on the premises of an enterprise or another entity. In some embodiments, the user sentiment evaluation server 105, or portions thereof, may be implemented as part of a storage system or on a host device. As also depicted in FIG. 1, the user sentiment evaluation server 105 further comprises an audio/video preprocessing module 112, an audio/video sentiment analysis module 114, a combined sentiment analysis module 116 and a sentiment-based remedial action module 118. In some embodiments, the audio/video preprocessing module 112 preprocesses audio and video signals to transform them into a format suitable for ingestion by the disclosed machine learning models, as discussed further below in conjunction with FIG. 3. The audio/video sentiment analysis module 114 evaluates the audio and video signals to determine a respective audio sentiment score and video sentiment score, as discussed further below in conjunction with FIG. 3. The combined sentiment analysis module 116 aggregates the audio sentiment score and the video sentiment score to determine an aggregate sentiment score. The sentiment-based remedial action module 118 triggers one or more automated remedial actions, discussed below, based on the aggregate sentiment score.

It is to be appreciated that this particular arrangement of modules 112, 114, 116 and 118 illustrated in the user sentiment evaluation server 105 of the FIG. 1 embodiment is presented by way of example only, and alternative arrangements can be used in other embodiments. For example, the functionality associated with modules 112, 114, 116 and 118 in other embodiments can be combined into a single module, or separated across a larger number of modules. As another example, multiple distinct processors can be used to implement different ones of modules 112, 114, 116 and 118 or portions thereof.

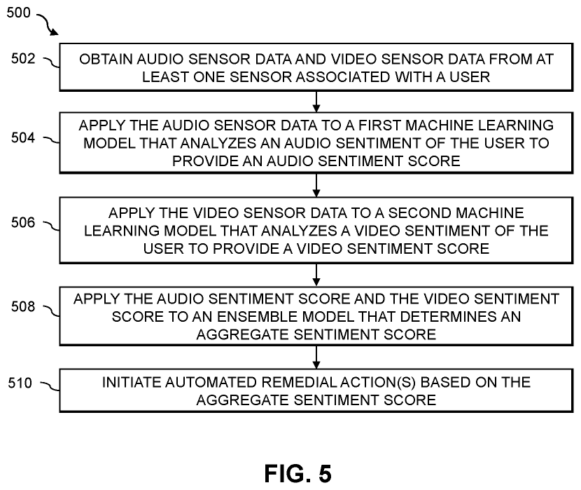

At least portions of modules 112, 114, 116 and 118 may be implemented at least in part in the form of software that is stored in memory and executed by a processor. An exemplary process utilizing modules 112, 114, 116 and 118 of an example user sentiment evaluation server 105 in computer network 100 will be described in more detail with reference to the flow diagrams of, for example, FIGS. 3 and 5.

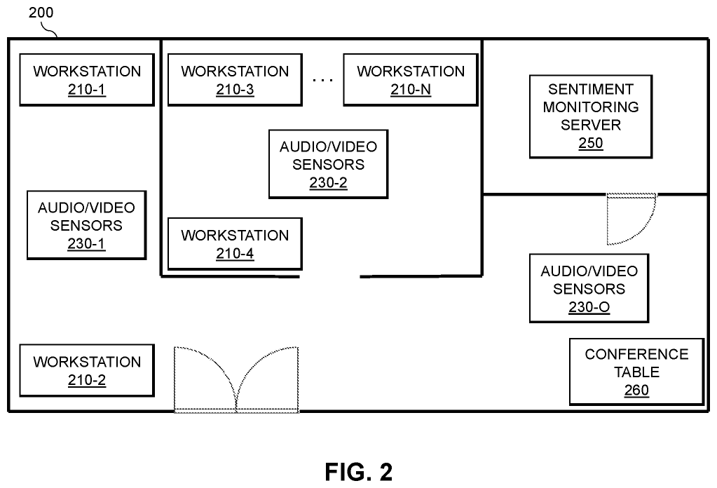

Additionally, the user sentiment evaluation server 105 can have an associated user database 106 configured to store, for example, assignments of users to work in particular locations (e.g., rooms or at specific workstations), for example, as well as historical user sentiment information, as discussed further below in conjunction with FIGS. 2 through 5. In addition, the user database 106 may also store human resource records, user credentials, user authorizations and/or identifiers of the authorized users in particular environments (e.g., of each team member, department member, division member or enterprise member).

The user database 106 in the present embodiment is implemented using one or more storage systems associated with the user sentiment evaluation server 105. Such storage systems can comprise any of a variety of different types of storage such as, network-attached storage (NAS), storage area networks (SANs), direct-attached storage (DAS) and distributed DAS, as well as combinations of these and other storage types, including software-defined storage.

The user devices 102 and the user sentiment evaluation server 105 may be implemented on a common processing platform, or on separate processing platforms. The user devices 102 are configured to interact over the network 104 with the user sentiment evaluation server 105.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for the user devices 102 and the user sentiment evaluation server 105 to reside in different locations (e.g., data centers). Numerous other distributed implementations of the user devices 102 and the user sentiment evaluation server 105 are possible.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the user devices 102 and/or the user sentiment evaluation server 105 can be one or more input-output devices (not shown), which illustratively comprise keyboards, displays or other types of input-output devices in any combination. Such input-output devices can be used, for example, to support one or more user interfaces to the user sentiment evaluation server 105, as well as to support communication between the user sentiment evaluation server 105 and other related systems and devices not explicitly shown.

The user devices 102 and the user sentiment evaluation server 105 in the FIG. 1 embodiment are assumed to be implemented using at least one processing device. Each such processing device generally comprises at least one processor and an associated memory, and implements one or more functional modules for controlling certain features of the user sentiment evaluation server 105.

More particularly, user devices 102 and user sentiment evaluation server 105 in this embodiment each can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs. One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including SSDs, and should therefore not be viewed as limited in any way to spinning magnetic media.

The network interface allows the user devices 102 and/or the user sentiment evaluation server 105 to communicate over the network 104 with each other (as well as one or more other networked devices), and illustratively comprises one or more conventional transceivers.

It is to be understood that the particular set of elements shown in FIG. 1 for machine learning-based user sentiment prediction using audio and video sentiment analysis is presented by way of illustrative example only, and in other embodiments additional or alternative elements may be used. Thus, another embodiment includes additional or alternative systems, devices and other network entities, as well as different arrangements of modules and other components.

FIG. 2 illustrates an exemplary layout of a space 200 in an exemplary office environment in accordance with one embodiment of the disclosure. In the example of FIG. 2, the exemplary space 200 comprises a plurality of workstations 210-1 through 210-N, collectively referred to herein as workstations 210 and one or more conference tables 260 in a plurality of rooms. At least some of the rooms have corresponding audio/video sensors 230-1 through 230-0. Thus, in the example of FIG. 2 it is not necessary that each workstation 210 or other user device 102 has a dedicated audio/video sensor 103.

In addition, in the example of FIG. 2, the exemplary space 200 comprises a sentiment monitoring server 250 which may be embodied as the user sentiment evaluation server 105 of FIG. 1. The sentiment monitoring server 250 automatically determines a sentiment of one or more users in the space 200, for example, when the user works at a particular workstation 210 or conference table 260, as discussed further below. The sentiment monitoring server 250 automatically evaluates the user sentiment in the space 200 using the disclosed audio and video sentiment analysis techniques.

FIG. 3 illustrates an exemplary prediction of user sentiment using audio and video sentiment analyzers in accordance with an illustrative embodiment. In the example of FIG. 3, one or more audio sensors 310 (e.g., microphones) and one or more video sensors 330 (e.g., cameras) are employed. The audio sensors 310 and video sensors 330 gather data that is used for the sentiment analysis. It is noted that in some embodiments, the audio sensors 310 and video sensors 330 may be implemented as a single video camera that provides an audio signal and an image stream.

As shown in FIG. 3, the sensor data generated by the audio sensors 310 is preprocessed by an audio preprocessor 315. In some embodiments, speech recognition techniques are employed to translate spoken words into text. Speech recognition involves capturing and digitizing the sound waves, converting them to basic language units or phonemes, constructing words from phonemes, and contextually analyzing the words to ensure correct spelling for words that sound alike. Voice recognition models typically process pre-processed input data. For example, the audio preprocessor 315 may convert the audio signal to a Mel Frequency Cepstral Coefficients (MFCC) format.

In one exemplary implementation, the audio preprocessor 315 slices the audio signal into frames (e.g., each having a duration between 20-40 ms), with each frame overlapping by 10-15 ms. An MFCC format is then generated for the audio frames, and the top N (e.g., N=13) MFCC features can be selected to send to the machine learning model (e.g., the machine learning model of the audio sentiment analyzer 320, discussed below). The frequency of each saved keyword is determined and applied as an input to the machine learning model.

The preprocessed audio signal from the audio preprocessor 315 is then applied to the audio sentiment analyzer 320 that generates an audio sentiment score. In some embodiments, the generated audio sentiment score may comprise a score matrix with a probability of each predefined sentiment category.

The audio sentiment analyzer 320 may be implemented, for example, as a deep learning model. The model of the audio sentiment analyzer 320 can be based on recurrent neural networks (RNNs), such as long short-term memory (LS™) or transformers, such as Bidirectional Representation for Transformers (BERT) for sentiment analysis.

In addition, the sensor data generated by the video sensors 330 is preprocessed by a video preprocessor 335. In some embodiments, facial recognition techniques are employed to match a human face from a digital image or a video frame against a database of faces, typically employed to authenticate users through identity verification services, for example, by pinpointing and measuring facial features from a given image.

Facial recognition models typically process preprocessed input data. For example, the video preprocessor 335 may cut the video signal into frames and store the frames as images. Human faces can be detected in each image using a face detection application programming interface (API). All frames in the video signal can be cropped using the same face location so that human face images are obtained.

The preprocessed video signal is then applied to a video sentiment analyzer 340 that generates a video sentiment score. In some embodiments, the generated video sentiment score may comprise a score matrix with a probability of each predefined sentiment category. The video sentiment analyzer 340 may be implemented as a deep learning model, such as a Convolutional Neural Network (CNN) for the processing of images as well as an RNN layer due to the sequential nature of the input.

In some embodiments, the machine learning models associated with the audio sentiment analyzer 320 and/or the video sentiment analyzer 340 may use training data based at least in part on the following training datasets: (i) CMU Multimodal Opinion Sentiment and Emotion Intensity (CMU-MOSEI) dataset for multimodal sentiment analysis and emotion recognition; and/or (ii) Interactive Emotional Dyadic Motion Capture (IEMOCAP) database comprising facial data with anchor points to aid video sentiment analysis.

The audio sentiment score and the video sentiment score generated by the audio sentiment analyzer 320 and the video sentiment analyzer 340, respectively, are applied to an ensemble model 350. In some embodiments, the ensemble model 350 is trained using the score matrices generated by the audio sentiment analyzer 320 and the video sentiment analyzer 340. The ensemble model 350 generates an aggregate sentiment score according to the applied audio sentiment score and video sentiment score.

In at least some embodiments, the ensemble model 350 comprises a deep learning model with inputs from the models of the audio sentiment analyzer 320 and the video sentiment analyzer 340 stacked over one another, and employs a stacking approach to determine the aggregate sentiment score. The stacking approach determines how to best combine the applied audio sentiment score prediction and video sentiment score prediction from the machine learning models of the audio sentiment analyzer 320 and the video sentiment analyzer 340, respectively. Among other benefits, a stacking approach can harness the capabilities of a range of well-performing models on a classification or regression task and make predictions that have better performance than any single model in the ensemble.

The exemplary ensemble model 350 employs a linear model with two hyperparameters α and β, using the following equation:

score=α*s₁+β*s₂+c,

where:

s₁: score matrix from model of audio sentiment analyzer 320,

α: weight matrix given to s₁ by ensemble model 350,

s₂: score matrix from model of video sentiment analyzer 340,

β: weight matrix given to s₂ by ensemble model 350, and

c: constant.

The preprocessed video signals from the video preprocessor 335 are also applied to an exclusion analyzer 345 that generates an exclusionary score. In one or more embodiments, the exclusion analyzer 345 comprises a computer vision model that will identify the exclusion of a section of the workforce from social activities or informal team gatherings like team huddles using a CNN model, such as a region-based CNN (R-CNN) model to perform object detection. The R-CNN model of the exclusion analyzer 345 will consume the preprocessed video signals from the video sensors, such as static cameras.

In some embodiments, the R-CNN model comprises multiple CNN layers followed by fully connected layers. A sigmoid layer comprising a sigmoid function can be attached in some embodiments at the end of the fully connected layers to detect if the weighted preprocessed video signals from the video sensors demonstrates an exclusion of a section of the workforce from social activities or informal team gatherings. The sigmoid function, f(t), produces similar results to a step function in that the output is typically between 0 and 1. The sigmoid function can be expressed in some embodiments as follows:

$$f ( t ) = \frac{1}{1 + {e}^{- 1}} .$$

The R-CNN model of the exclusion analyzer 345 will be trained, in some embodiments, on annotated images to recognize people in a scene. The trained mask R-CNN model will be used as a base model. Transfer learning can be applied to the base model to specifically focus on people in the scene. Samples from a corporate environment (such as desks, cubicles, meeting rooms, open plan and more) will also be obtained as an additional source of training data. Each object identified in the preprocessed video images will be annotated in some embodiments with a bounding box to denote the presence of the corresponding object in an image. For example, people in a sample image can be annotated using a bounding box around each person. The annotated and preprocessed video images are then passed into the R-CNN model of the exclusion analyzer 345 for training purposes. Generally, the bounding boxes are used to identify one or more individuals that are separated from a group of persons. In some embodiments, facial recognition can be used to recognize specific individuals and specific members of a particular grouping of employees (such as a department or team). In addition, human resource records and scheduling data can be processed to identify a time and location of particular group meeting.

The exclusion analyzer 345 further comprises an inference engine that will process each frame from the R-CNN model with the preprocessed video images annotated with the bounding boxes around each object and locations of people in each image. For purposes of illustration, assume that there are two groups of people in a scene. A first group comprises multiple individuals and the second group comprises a single person. With the result from the R-CNN model, pixel coordinates can be used to identify the distance between the different bounding boxes. In this example, the single person in the second grouping would be deemed excluded from the first group.

In some embodiments, properties associated with each camera stream can be processed to evaluate the amount of distance between groups in order to identify separate groups of people. This may be important in a corporate setting, for example, where some desks are closely located making it harder to detect exclusion.

As shown in FIG. 3, the aggregate sentiment score generated by the ensemble model 350 and the exclusionary score from the model of the exclusion analyzer 345 are then applied to a combined sentiment analyzer 360 that comprises another machine learning model, in at least some embodiments. The model of the combined sentiment analyzer 360 produces the final sentiment score based on a combination of the aggregate score from the ensemble model 350 and the exclusionary score from the model of the exclusion analyzer 345.

In the example of FIG. 3, the final sentiment score from the combined sentiment analyzer 360 is applied to feedback agents 365-1 and 365-2, an Internet of Things (IoT) control module 370 and an action manager 380. The feedback agents 365-1 and 365-2 process the final sentiment score from the combined sentiment analyzer 360, and optionally user feedback ratings indicating whether the generated final sentiment score and/or exclusionary score are accurate, to update and/or retrain the respective models of the audio sentiment analyzer 320, the video sentiment analyzer 340 and/or the exclusion analyzer 345. In this manner, the accuracy of the audio sentiment analyzer 320, the video sentiment analyzer 340 and/or the exclusion analyzer 345 can be improved over time.

In the embodiment shown in FIG. 3, the audio sentiment analyzer 320, the video sentiment analyzer 340 and the exclusion analyzer 345 are illustrated as being distinct from one another. In addition, the audio sentiment analyzer 320, the video sentiment analyzer 340 and the exclusion analyzer 345 in the example of FIG. 3 each comprise distinct models relative to one another. In other embodiments, two or more of the audio sentiment analyzer 320, the video sentiment analyzer 340 and the exclusion analyzer 345 may employ a shared machine learning model, or one or more portions of a given machine learning model may be shared by two or more of the audio sentiment analyzer 320, the video sentiment analyzer 340 and the exclusion analyzer 345.

In one or more embodiments, the IoT control module 370 is implemented as a central agent that selects one or more automated remedial actions to perform using other IOT devices (not shown) on the network. The IoT control module 370 receives the output of the final sentiment score and determines a course of action (for example, in accordance with a predefined policy) in order to improve the workplace environment for one or more employees, when suggested by the final sentiment score. For example, remedial action may be appropriate when there has been a sudden drop in the final sentiment score that suggests that there is tension in the workplace environment and employees are feeling uneasy.

In at least one exemplary implementation, the IoT control module 370 can initiate one or more of the following the actions:
adjust the lighting of the workplace environment to a softer and less intense light (which may have a positive impact on the employees, causing them to relax and feel less stressed);
adjust the temperature of the workplace environment based on the sentiment score (e.g., if a facial impression of one or more employees is showing that employees are warmer than usual, then the environment temperature can be lowered to help make employees more comfortable);
adjust a music source to play slow and stress-free music which can help employees relax during long working hours (for example, when a decrease in the final sentiment score indicates that employees are getting distracted and are tense); and
infuse the workplace environment with calming and/or soothing scents.

The action manager 380 of FIG. 3 processes the final sentiment score to influence a policy execution in real-time. The final sentiment score and other data can be compiled and sent to respective management or facilities teams, for example, in the form of a report. The results can be compiled manually, or a software script can do the necessary work, as needed. As a given company introduces new policies, the final sentiment score can be evaluated over time and provided to management to show an effectiveness of the new policies. In addition, the action manager 380 may generate one or more real-time alerts to notify the appropriate individuals if there has been a sudden change in the final sentiment score to help such individuals determine the root cause for the drop in the final sentiment score.

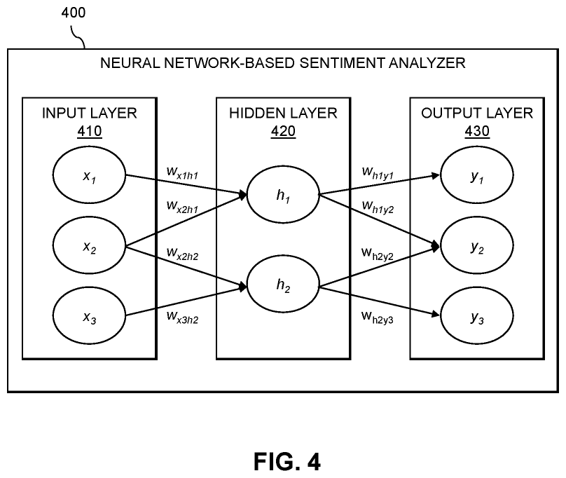

FIG. 4 illustrates a neural network-based sentiment analyzer 400 in accordance with an illustrative embodiment. In the example of FIG. 4, the neural network-based sentiment analyzer 400 comprises an input layer 410, one or more hidden layers (e.g., a hidden layer 420 in the example of FIG. 4), and an output layer 430. Input layer 410 can include a number of neurons that matches the number of input and/or independent variables. For instance, in the example of FIG. 4, input layer 410 includes neurons corresponding at least to a first variable (x₁), a second variable (x₂) and a third variable (x₃). Hidden layer 420 in the example embodiment of FIG. 4, includes one layer comprising two neurons (h₁ and h₂). The exemplary output layer 430 comprises three neurons (y₁, y₂ and y₃).

Accordingly, while there are two neurons/nodes shown in the hidden layer 420 in the FIG. 4 example, the actual number of nodes can depend upon the total number of neurons in the input layer 410. At least one embodiment includes implementing one or more methods of calculation based on the number of nodes in the input layer 410. For example, the number of nodes in the hidden layer 420 of a particular implementation can be determined using experimentation to discover what works best for a given dataset.

In the example neural network-based sentiment analyzer 400 depicted in FIG. 4, each node will connect with one or more additional nodes. Each connection between nodes may have a weight factor (w), such as the weight factor wₓ₁ₕ₁ for the connection between the x₁ and h₁ nodes. The nodes in the one or more hidden layers (e.g., hidden layer 420) and output layer 430 may have a bias factor (such as, for example, b₂₁, b₂₂, for the nodes in the hidden layer 420, and b₃₁, b₃₂, b₃₃ for the three nodes in the output layer 430). These weight and bias values can be calculated during a training phase, for example, or set randomly by the neural network, and can be started as 1 or 0 for all values. The weights and biases are learnable parameters of the machine learning model. When the input values are transmitted between neurons, the weights are applied to the input values along with the bias. The bias unit substantially guarantees that even when all of the input values are zeros there will still be activation in the neuron. In such an embodiment, each neuron/node performs a linear calculation by combining the multiplication of each input variable (x₁, x₂ . . . ) with their weight factors, and then adding the bias of the neuron.

FIG. 5 is a flow chart illustrating an exemplary implementation of a process 500 for predicting user sentiment using audio and video sentiment analysis in accordance with an illustrative embodiment. As shown in the example of FIG. 5, the exemplary process 500 initially obtains audio sensor data and video sensor data in step 502 from at least one sensor associated with at least one user. For example, the at least one user may comprise a video camera that captures both the audio data and the video data. In step 504, at least some of the audio sensor data is applied to a first machine learning model that analyzes an audio sentiment of the at least one user to provide at least one audio sentiment score. In step 506, at least some of the video sensor data is applied to a second machine learning model that analyzes a video sentiment of the at least one user to provide at least one video sentiment score. The at least one audio sentiment score and the at least one video sentiment score are applied in step 508 to an ensemble model that determines an aggregate sentiment score based at least in part on the at least one audio sentiment score and the at least one video sentiment score. Finally, in step 510, one or more automated remedial actions are initiated in step 510 based at least in part on the aggregate sentiment score.

The particular processing operations and other network functionality described in conjunction with the flow diagram of FIG. 5, for example, are presented by way of illustrative example only, and should not be construed as limiting the scope of the disclosure in any way. Alternative embodiments can use other types of processing operations to predict user sentiment using audio and video sentiment analysis. For example, the ordering of the process steps may be varied in other embodiments, or certain steps may be performed concurrently with one another rather than serially. In one aspect, the process can skip one or more of the actions. In other aspects, one or more of the actions are performed simultaneously. In some aspects, additional actions can be performed.

In some embodiments, the process 500 may also comprise providing an output of the ensemble model to at least one feedback agent that updates the first machine learning model and/or the second machine learning model. In addition, at least some of the audio sensor data and/or the video sensor data can be preprocessed to satisfy one or more data processing criteria of the first machine learning model and/or the second machine learning model. For example, the preprocessing of at least some of the audio sensor data and/or the video sensor may comprise: (i) selecting a number audio features to send to the first machine learning model and/or (ii) detecting one or more human faces in the video sensor data and cropping one or more image frames using the detected one or more human faces.

In another example, the one or more automated remedial actions performed by the process 500 may comprise: generating a notification, adjusting a temperature of a workspace area associated with the at least one user, adjusting a lighting of the workspace area associated with the at least one user, adjusting one or more of a volume and a content of music presented in the workspace area associated with the at least one user, and/or adjusting one or more scents provided in the workspace area associated with the at least one user.

The at least one audio sentiment score and/or the at least one video sentiment score of the process 500 may comprise a score matrix indicating a probability score for each of a plurality of sentiment categories. In addition, the process 500 may also comprise processing at least some of the video sensor data to identify one or more user classes that are excluded from group meetings and/or group activities by evaluating pixel coordinates of at least some of the objects in a given image associated with users to identify the one or more user classes that are excluded from the group meetings and/or the group activities

One or more aspects of the disclosure recognize that workplace discrimination is an important issue that can prevent an organization from fully utilizing its human resources. Workplace discrimination has been categorized as a big hurdle for any organization that is expanding in various regions or parts of the world. Organizations often take a number of measures to counter workplace discrimination, such as providing proper channels to communicate and share any grievances. Nonetheless, a section of the workforce may be excluded from a group in a manner that is not very transparent, such as leaving out a person belonging to a minority group from group activities. The excluded group (or individual) may not report the exclusion because of, for example, peer pressure, manager pressure, or fear of getting terminated.

In some implementations, a portal can be provided that allows an interested person to review the generated sentiment data in accordance with a selected granularity level (e.g., floor, building, city, or country). In this manner, personal can relate changes in sentiment to recent policy changes, for example.

To address privacy concerns, one or more embodiments of the disclosure may not track individuals. For example, in considering the privacy of the workforce, one or more of the following controls may optionally be employed: (i) audio sensors may only sense specific approved keywords (e.g., already stored in the system), such as “good morning,” and “happy,” and do not record the general conversation; (ii) the audio sentiment analysis may not store the data corresponding to any individual employee, rather the frequency of the keywords is stored and used to determine the sentiment of any team workspace; (iii) the video sentiment analysis may use facial recognition to generate real-time sentiment but not persist the data (thus, only the sentiment data is stored and not the actual captured video); (iv) the audio and video sensors may only be placed in a common working space and not in a personal space, such as a relaxing room or locker room; and (v) the models are used to determine the sentiment of a team working environment or defined space.

The disclosed machine learning-based techniques for user sentiment prediction can be employed, for example, to (i) monitor a workplace environment in real-time to ensure that employees are getting an opportunity to work in a positive environment and to reach their full potential, (ii) ensure that the workplace demonstrates diversity and to reduce workplace discrimination, (iii) reduce dependence on employee surveys where employees can give false feedback under pressure from a supervisor or another colleague, and (iv) analyze whether the policies implemented to improve the workplace environment are working in the day-to-day office environment.

One or more embodiments of the disclosure provide improved methods, apparatus and computer program products for predicting user sentiment using audio and video sentiment analysis. The foregoing applications and associated embodiments should be considered as illustrative only, and numerous other embodiments can be configured using the techniques disclosed herein, in a wide variety of different applications.

It should also be understood that the disclosed user sentiment prediction techniques, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed machine learning-based techniques for user sentiment prediction using audio and video sentiment analysis may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services can be offered to cloud infrastructure tenants or other system users as a PaaS offering, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based user sentiment prediction engine, or portions thereof, are illustratively implemented for use by tenants of such a multi-tenant environment.

Cloud infrastructure as disclosed herein can include cloud-based systems such as AWS, GCP and Microsoft Azure. Virtual machines provided in such systems can be used to implement at least portions of a cloud-based user sentiment prediction platform in illustrative embodiments. The cloud-based systems can include object stores such as Amazon S3, GCP Cloud Storage, and Microsoft Azure Blob Storage.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

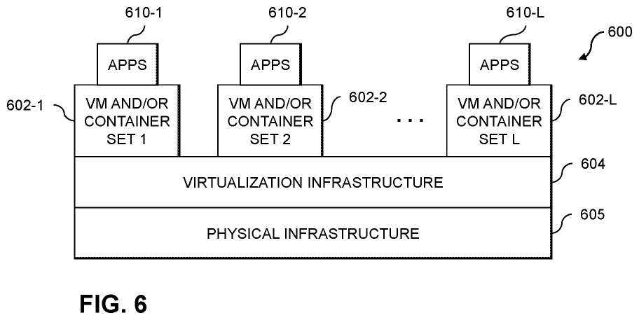

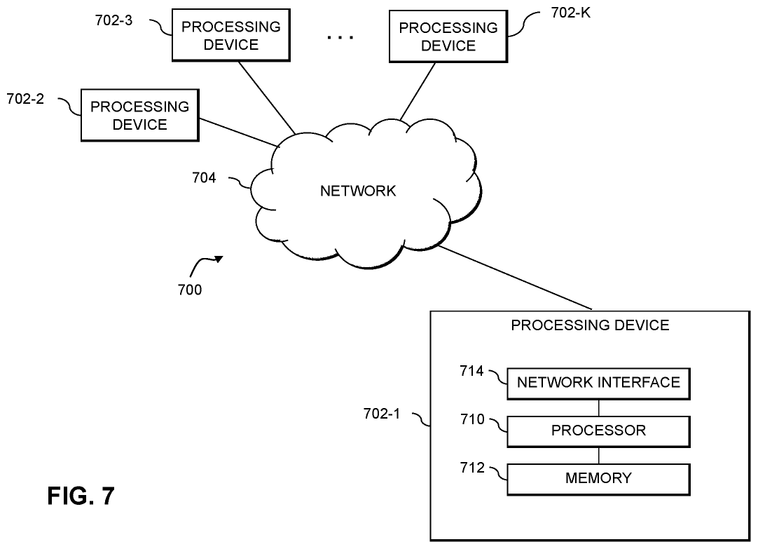

Illustrative embodiments of processing platforms will now be described in greater detail with reference to FIGS. 6 and 7. These platforms may also be used to implement at least portions of other information processing systems in other embodiments.

FIG. 6 shows an example processing platform comprising cloud infrastructure 600. The cloud infrastructure 600 comprises a combination of physical and virtual processing resources that may be utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. Such implementations can provide user sentiment prediction functionality of the type described above for one or more processes running on a given one of the VMs. For example, each of the VMs can implement user sentiment prediction control logic and associated functionality for implementing remedial measures for one or more processes running on that particular VM.

An example of a hypervisor platform that may be used to implement a hypervisor within the virtualization infrastructure 604 is the VMware® vSphere® which may have an associated virtual infrastructure management system such as the VMware® vCenter™. The underlying physical machines may comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system. Such implementations can provide user sentiment prediction functionality of the type described above for one or more processes running on different ones of the containers. For example, a container host device supporting multiple containers of one or more container sets can implement one or more instances of user sentiment prediction control logic and associated functionality for implementing remedial measures.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises at least a portion of the given system and includes a plurality of processing devices, denoted 702-1, 702-2, 702-3, . . . 702-K, which communicate with one another over a network 704. The network 704 may comprise any type of network, such as a WAN, a LAN, a satellite network, a telephone or cable network, a cellular network, a wireless network such as WiFi or WiMAX, or various portions or combinations of these and other types of networks.

The processing device 702-1 in the processing platform 700 comprises a processor 710 coupled to a memory 712. The processor 710 may comprise a microprocessor, a microcontroller, an ASIC, an FPGA or other type of processing circuitry, as well as portions or combinations of such circuitry elements, and the memory 712, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 6 or 7, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining audio sensor data and video sensor data from at least one sensor associated with at least one user;
applying at least some of the audio sensor data to a first machine learning model that analyzes an audio sentiment of the at least one user to provide at least one audio sentiment score;
applying at least some of the video sensor data to a second machine learning model that analyzes a video sentiment of the at least one user to provide at least one video sentiment score;
applying the at least one audio sentiment score and the at least one video sentiment score to an ensemble model that determines an aggregate sentiment score based at least in part on the at least one audio sentiment score and the at least one video sentiment score; and
initiating one or more automated remedial actions based at least in part on the aggregate sentiment score;
wherein the method is performed by at least one processing device comprising a processor coupled to a memory.

2. The method of claim 1, further comprising providing an output of the ensemble model to at least one feedback agent that updates one or more of the first machine learning model and the second machine learning model.

3. The method of claim 1, further comprising preprocessing at least some of one or more of the audio sensor data and the video sensor data to satisfy one or more data processing criteria of one or more of the first machine learning model and the second machine learning model.

4. The method of claim 3, wherein the preprocessing comprises one or more of: (i) selecting a number of audio features to send to the first machine learning model and (ii) detecting one or more human faces in the video sensor data and cropping one or more image frames using the detected one or more human faces.

5. The method of claim 1, wherein the one or more automated remedial actions comprise one or more of: generating a notification, adjusting a temperature of a workspace area associated with the at least one user, adjusting a lighting of the workspace area associated with the at least one user, adjusting one or more of a volume and a content of music presented in the workspace area associated with the at least one user, and adjusting one or more scents provided in the workspace area associated with the at least one user.

6. The method of claim 1, wherein one or more of the at least one audio sentiment score and the at least one video sentiment score comprises a score matrix indicating a probability score for each of a plurality of sentiment categories.

7. The method of claim 1, further comprising processing at least some of the video sensor data to identify one or more user classes that are excluded from one or more of group meetings and group activities by evaluating pixel coordinates of at least some objects in a given image associated with users to identify the one or more excluded user classes.

8. An apparatus comprising:
at least one processing device comprising a processor coupled to a memory;
the at least one processing device being configured to implement the following steps:
obtaining audio sensor data and video sensor data from at least one sensor associated with at least one user;
applying at least some of the audio sensor data to a first machine learning model that analyzes an audio sentiment of the at least one user to provide at least one audio sentiment score;
applying at least some of the video sensor data to a second machine learning model that analyzes a video sentiment of the at least one user to provide at least one video sentiment score;
applying the at least one audio sentiment score and the at least one video sentiment score to an ensemble model that determines an aggregate sentiment score based at least in part on the at least one audio sentiment score and the at least one video sentiment score; and
initiating one or more automated remedial actions based at least in part on the aggregate sentiment score.

9. The apparatus of claim 8, further comprising providing an output of the ensemble model to at least one feedback agent that updates one or more of the first machine learning model and the second machine learning model.

10. The apparatus of claim 8, further comprising preprocessing at least some of one or more of the audio sensor data and the video sensor data to satisfy one or more data processing criteria of one or more of the first machine learning model and the second machine learning model.

11. The apparatus of claim 10, wherein the preprocessing comprises one or more of: (i) selecting a number of audio features to send to the first machine learning model and (ii) detecting one or more human faces in the video sensor data and cropping one or more image frames using the detected one or more human faces.

12. The apparatus of claim 8, wherein the one or more automated remedial actions comprise one or more of: generating a notification, adjusting a temperature of a workspace area associated with the at least one user, adjusting a lighting of the workspace area associated with the at least one user, adjusting one or more of a volume and a content of music presented in the workspace area associated with the at least one user, and adjusting one or more scents provided in the workspace area associated with the at least one user.

13. The apparatus of claim 8, wherein one or more of the at least one audio sentiment score and the at least one video sentiment score comprises a score matrix indicating a probability score for each of a plurality of sentiment categories.

14. The apparatus of claim 8, further comprising processing at least some of the video sensor data to identify one or more user classes that are excluded from one or more of group meetings and group activities by evaluating pixel coordinates of at least some objects in a given image associated with users to identify the one or more excluded user classes.

15. A non-transitory processor-readable storage medium having stored therein program code of one or more software programs, wherein the program code when executed by at least one processing device causes the at least one processing device to perform the following steps:
obtaining audio sensor data and video sensor data from at least one sensor associated with at least one user;
applying at least some of the audio sensor data to a first machine learning model that analyzes an audio sentiment of the at least one user to provide at least one audio sentiment score;
applying at least some of the video sensor data to a second machine learning model that analyzes a video sentiment of the at least one user to provide at least one video sentiment score;
applying the at least one audio sentiment score and the at least one video sentiment score to an ensemble model that determines an aggregate sentiment score based at least in part on the at least one audio sentiment score and the at least one video sentiment score; and
initiating one or more automated remedial actions based at least in part on the aggregate sentiment score.

16. The non-transitory processor-readable storage medium of claim 15, further comprising providing an output of the ensemble model to at least one feedback agent that updates one or more of the first machine learning model and the second machine learning model.

17. The non-transitory processor-readable storage medium of claim 15, further comprising preprocessing at least some of one or more of the audio sensor data and the video sensor data to satisfy one or more data processing criteria of one or more of the first machine learning model and the second machine learning model.

18. The non-transitory processor-readable storage medium of claim 17, wherein the preprocessing comprises one or more of: (i) selecting a number of audio features to send to the first machine learning model and (ii) detecting one or more human faces in the video sensor data and cropping one or more image frames using the detected one or more human faces.

19. The non-transitory processor-readable storage medium of claim 15, wherein one or more of the at least one audio sentiment score and the at least one video sentiment score comprises a score matrix indicating a probability score for each of a plurality of sentiment categories.

20. The non-transitory processor-readable storage medium of claim 15, further comprising processing at least some of the video sensor data to identify one or more user classes that are excluded from one or more of group meetings and group activities by evaluating pixel coordinates of at least some objects in a given image associated with users to identify the one or more excluded user classes.
